(19) United States
(12) Patent Application Publication
(10) Pub. No.: US 2008/0059257 A1
(43) Pub. Date: Mar. 6, 2008

(54) System for performing a competitive assessment

(75) Inventors: Robert A. Farmer, Morton, IL (US); Gordon D. Ferguson, Peoria, IL (US); Ernest P. Thomatis, Chicago, IL (US); Steven L. Vanne, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/513,108

(22) Filed: Aug. 31, 2006

(51) Int. Cl. G06F 9/44

(52) U.S. Cl. 705/7

(57) ABSTRACT

A system for performing a competitive assessment including a method for evaluating at least one operation associated with a market sector is disclosed. The method includes determining a first entity and at least one second entity, each performing the at least one operation within the market sector to separately produce a desired output. The method also includes compiling data indicative of the first entity and the at least one second entity respectively performing the at least one operation. The method also includes determining a first value and at least one second value as a function of the compiled data. The first and at least one second value are indicative of a respective ability of the first and the at least one second entity to perform the at least one operation. The method further includes evaluating the at least one operation as an advantage of the first entity over the second entity with respect to the market sector if the first value is greater than the at least one second value.

### TECHNICAL FIELD

The present disclosure relates to a system for performing an assessment and, more particularly, to a method and apparatus for performing a competitive assessment.

### BACKGROUND

An entity, e.g., a firm or company, often competes within a particular market sector with one or more other entities and often performs one or more interrelated operations to execute and/or achieve an output product or service associated with the market sector. For example, an entity may perform a receiving, a warehousing, and a delivery operation for one or more products as part of a particular market sector, e.g., product distribution. Often, each entity competing within a market sector performs the one or more operations differently, e.g., one entity performs an electronic receiving operation and another entity performs a hardcopy receiving operation, and/or performs a similar operation at different levels of proficiency, e.g., one entity performs a shipping operation with 1% errors and another entity performs a similar type shipping operation with 4% errors. Entities often attempt to identify competitive advantages or disadvantages with respect to other entities within a common market sector by evaluating internal operations and identifying operations and/or sub-operations which are imitatable by competitors, e.g. relatively easy or difficult to imitate, or are perceived by customers as providing quality to the output product or service, e.g., operations distinguishing one entity's output as superior relative to other entities' outputs. Additionally, entities attempt to identify competitive advantages and disadvantages by evaluating operations of one or more competing entities with respect to internal operations. Although an entity may have significant and/or quality data with respect to internal operations, data with respect to competitor operations may be more difficult to obtain and/or less reliable. Additionally, a market sector may include numerous operations and sub-operations and the respective interrelation and/or significance thereof may be arbitrarily determined based upon experience of an evaluator.

U.S. Pat. No. 6,249,768 issued to Tulskie Jr. et al. (“the '768 patent) discloses a system for modeling an integrated framework of a firm with respect to resources, capabilities, and strategic positions. Each of the capabilities is related by identifying if the capability either supports or conflicts with another capability and/or with a value position. Capabilities represent the one or more operations or attributes an entity performs or possesses that are directed toward achieving one or more strategic goals represented as value positions. The model of the '768 patent can be utilized to evaluate an entity's operations within a market sector, evaluate the influence, e.g., benefit or detriment, to one or more value positions, and/or identify capabilities that are redundant, unnecessary, or under performing.

Although the system of the '768 patent models an entity's capabilities and their interrelation to one another and value positions, it may not compare one or more capabilities of the entity with a respective capability of the entity's competitors. Additionally, the system of the '768 patent may determine the effectiveness of a capability but may not evaluate the quality of a particular internal capability and the quality of respective capabilities of competitors. Furthermore, the system of the '768 patent may identify advantages and disadvantages with respect to one or more capabilities and their interrelationship, i.e., internally, but may not identify advantages and disadvantages with respect to capabilities of one or more competing entities, i.e., externally.

The present disclosure is directed to overcoming one or more of the shortcomings set forth above.

### SUMMARY OF THE INVENTION

In one aspect, the present disclosure is directed to a method for evaluating at least one operation associated with a market sector. The method includes determining a first entity and at least one second entity, each performing the at least one operation within the market sector to separately produce a desired output. The method also includes compiling data indicative of the first entity and the at least one second entity respectively performing the at least one operation. The method also includes determining a first value and at least one second value as a function of the compiled data. The first and at least one second value are indicative of a respective ability of the first and the at least one second entity to perform the at least one operation. The method further includes evaluating the at least one operation as an advantage of the first entity over the second entity with respect to the market sector if the first value is greater than the at least one second value.

In another aspect, the present disclosure is directed to a work environment for performing a competitive assessment between at least two entities competing within a market sector. The work environment includes a computer configured to receive a plurality of inputs from a user. At least a first portion of the plurality of inputs are indicative of an ability of each of the at least two entities for performing at least one operation associated with the market sector. The work environment also includes a database configured to store data indicative of the at least first portion of the plurality of inputs. The method further includes a program configured to perform a first algorithm configured to arrange the data within the database and operatively associate the data with each of the respective at least two entities.

In yet another aspect, the present disclosure is directed to a method for performing a competitive assessment. The method includes identifying at least one market sector in which an entity operates and determining at least one competitor with respect to the entity within the at least one market sector. The method also includes determining at least one operation separately performed by the entity and the at least one competitor to achieve respective outputs associated with the market sector. The method also includes establishing data associated with the at least one operation with respect to the entity and the at least one competitor. The method further includes determining ratings indicative of the entity and the at least one competitor performing the operation, evaluating the determined ratings with respect to one another, and identifying an advantage with respect to the entity if the rating for the entity is greater than the rating for the competitor.

### BRIEF DESCRIPTION OF THE DRAWINGS

FIG. 1 is a flow chart of an exemplary method for performing a competitive assessment in accordance with the present disclosure; and

FIG. 2 is a schematic illustration of an exemplary work environment for performing the method of FIG. 1.

### DETAILED DESCRIPTION

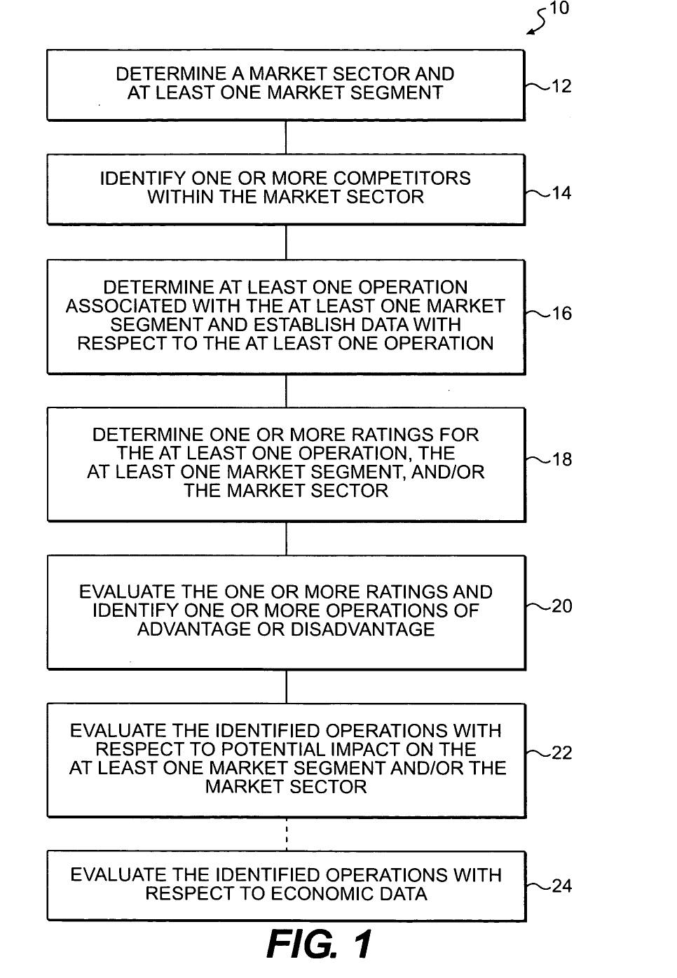

FIG. 1 illustrates an exemplary method 10 for performing a competitive assessment. Method 10 may include determining a market sector and at least one market segment, step 12, and identifying one or more competitors therein, step 14. Method 10 may also include determining at least one operation associated with the at least one market segment and establishing data with respect to the at least one operation, step 16. Method 10 may also include determining one or more combined ratings for the at least one operation, the at least one market segment, and/or the market sector, step 18. Method 10 may also include evaluating the one or more ratings and identifying one or more operations of advantage or disadvantage, step 20. Method 10 may also include evaluating the identified operations with respect to potential impact on the at least one market segment and/or market sector, step 22. Method 10 may further include evaluating the identified operations with respect to economic data, step 24. It is contemplated that method 10 may be performed continuously, periodically, singularly, as a batch method, and/or may be repeated as desired. It is also contemplated that one or more of the steps associated with method 10 may be selectively omitted, that the steps associated with method 10 may be performed in any order, and that the steps associated with method 10 are described herein in a particular sequence for exemplary purposes only.

Step 12 may include determining a market sector and at least one market segment. A market sector may include any type of business or industrial market wherein an entity, e.g., a firm, company, corporation, partnership, or other type of business entity, produces an output, e.g., a product or service, to be used, consumed, purchased, or otherwise utilized by another entity. For example, a first entity, e.g., a manufacturer, may operate within a manufacturing market sector and may be configured to manipulate raw materials into a finished product that may be purchased by a second entity, e.g., a wholesaler. Similarly, a first entity, e.g., a management firm, may operate within a product distribution market sector and may be configured to manage the receiving, warehousing, or transportation of products among a plurality of facilities associated with a second entity, e.g., a manufacturer. Specifically, step 12 may include identifying a market sector in which an entity, e.g., a primary entity, operates or desires to operate. An identified market sector may include one or more market segments which may be configured as components of the market sector. As discussed above, receiving and warehousing may be, for example, identified as market segments within a product distribution market sector. It is contemplated that step 12 may include identifying any number of market segments associated with the identified market sector.

Step 14 may include identifying at least one competitor of the primary entity, e.g., one or more entities producing outputs substantially similar to the output produced by the primary entity and thus being associated with the market sector. Specifically, step 14 may include researching the market segment and identifying one or more entities operating therein. For example, step 14 may include conducting market research to identify one, two, or more entities having the largest market shares within the identified market segment. Market share is a well known concept within the art and as such is not further described. It is contemplated that step 14 may include identifying one or more entities operating within the identified market segment according to any suitable criteria such as, for example, experience or other knowledge regarding the demographics of the identified market segment and/or entities having a market share greater than a predetermined market share.

Step 16 may include determining at least one operation associated with the at least one market segment and establishing data with respect to the at least one operation. The identified market segment may include one or more operations that may be interrelated and performed to produce intermediate stages of the output and/or the final output. The at least one operation may include, for example, any component or sub-division of the market segment. For example, if the market segment includes warehousing, the at least one operation may include cross docking, storing inventory or finished products, repacking, picking, sequencing, kitting, sub-assembling, shipping preparation or loading, other types of operations, and/or a combination of one or more such operations. It is contemplated that the market segment may be divided into any number of operations that may be defined and/or characterized according to any suitable criteria, such as, for example, experience, market definitions, and/or logical stages of product manipulation or service operations to achieve the output.

Step 16 may also include compiling data regarding the ability of the primary entity and the at least one competitor to perform the at least one operation. Specifically, step 16 may include conducting research and/or conducting one or more surveys. For example, step 16 may include conducting one or more surveys of present employees, former employees, and/or customers of a respective entity. The compiled data may include information or indicia indicative of the capability, deliverability, and/or quality of the entity's performance. Capability may include the ability of the entity to perform the operation, e.g., whether or not an entity possesses the resources, equipment, personnel, informational know-how, and/or other criteria representing an ability of an entity to perform the at least one operation. Deliverability may include the ability of the entity to provide the desired output of the at least one operation, e.g., whether the entity produces and/or delivers the desired output within one or more criteria. Quality may include the ability of an entity to satisfy and/or exceed the expectations of a customer obtaining the output, e.g., whether or not a customer perceives the characteristics of the output produced by the entity to be satisfactory for the intended use. Additionally, the capability, deliverability, and quality of an entity's ability to perform the at least one operation may be rated. For example, the capability, deliverability, and/or quality may be numerically rated with respect to the entity's perceived ability on a scale from no ability, e.g., zero, to predetermined maximum ability, e.g., 100. It is contemplated that an entity may or may not include the capability to perform a particular operation and if the entity does include the capability, may include any combination of deliverability and/or quality. It is also contemplated that the scale may include any quantity of levels and may, for example, include a four point scale represented by numerals zero for no ability, one for some ability, two for more ability, and three for maximum ability. It is also contemplated that the surveys may request that a respondent, e.g., an employee, identify whether an entity possesses each of the characteristics and, if so, to rate the ability with respect to the scale. It is further contemplated that the results from multiple surveys may be combined into a single rating according to any suitable method, e.g., averaging multiple ratings for each of a capability, deliverability, and/or quality for each operration.

Step 18 may include determining one or more combined ratings for the at least one operation, the market segment, and/or the market sector. Specifically, the market sector may include one or more market segments and a market segment may include one or more operations. As such, the capability, deliverability, and/or quality ratings may be combined to provide a combined rating of the at least one operation. Furthermore, the particular ratings for one or more interrelated operations may be combined with one another to provide a combined rating of a market segment and market sector, respectively. For example, one or more operations may be averaged, e.g., a weighted average with some of the operations having a higher weighting with respect to other operations. It is contemplated that the combined ratings may be determined for the primary entity and each of the competitor entities. It is also contemplated that, alternatively, ratings for any operation, market segment, and/or market sector may be combined in any suitable manner, such as, for example, summing. It is further contemplated that the weighting of operations and/or market segments may be determined via any suitable manner, such as, for example, by experience or expertise and may be indicative of one or more operations and/or market segments as being more critical or important than others and thereby establishing weightings for those operations and/or markets segments as being higher.

Step 20 may include evaluating the one or more ratings and identifying one or more operations of advantage or disadvantage. Specifically, step 20 may include comparing the respective combined ratings of the primary entity and the competitor entities with one another. If the combined rating for a particular entity, e.g., the primary entity, is higher than a combined rating for another entity, e.g., a competitor, it may be determined that the primary entity may have an advantage, e.g., a competitive advantage, with respect to the competitor. Similarly, if the opposite it true, e.g., if the combined rating for the primary entity is lower than the combined rating for the competitor, it may be determined that the primary entity has a disadvantage, e.g., a competitive disadvantage, with respect to the competitor. An advantage may be indicative of one entity performing the at least one operation more desirously, e.g., more economically, more efficiently, more satisfactory to a customer, less costly, less capital intensive, or less labor intensive, than another entity. It is contemplated that an advantage may be determined when a combined rating for one entity is greater than a combined rating for another entity. It is also contemplated that an advantage may be determined when a combined rating for one entity is greater than a combined rating for another entity plus a predetermined factor. It is also contemplated that step 20 may include determining a combined rating for each operation, market segment, and market sector for each entity, e.g., the primary entity and the one or more competitors, and may include identifying one or more advantages and/or disadvantages with respect to a particular entity. It is further contemplated that the primary entity may also identify threats, e.g., decreasing advantages, with respect to one or more of the competitors if a subsequent evaluation identifies a competitor having a current rating higher than a previous rating or if a competitor has a rating within a predetermined range with respect to the rating of the primary entity.

Step 22 may include evaluating the identified operations with respect to potential impact on the market segment and/or market sector. Specifically, step 22 may include comparing an identified operation of advantage and the impact that advantage has with respect to the market segment. For example, step 22 may include evaluating the weighting associated with an identified operation of advantage and identifying a substantial advantage if the weighting for the operation is relatively high with respect to weightings of other operations. Similarly, step 22 may include evaluating market segments and their respective impact on a market sector. As such, step 22 may identify one or more operations and/or market segments that may be considered to be important or more critical to the performance of an entity within a market segment or market sector. Such operations and/or market segments may be identified as more desirous opportunities for improvement, may be identified to receive relatively higher focus of entity resources, and, therefore, may be improved, e.g., a disadvantage may be eliminated or an advantage may be increased.

Step 24 may include evaluating the identified operations with respect to economic data. Specifically, step 24 may include comparing the one or more operations identified within step 22 with the projected revenue streams, e.g., a predetermined amount of revenue, associated with the operation, the market segment, and/or the market sector. Step 24 may include identifying revenue streams, which may be less impacted by cyclic, declining, speculative, and/or other potentially undesirable types of revenue streams. As such, step 24 may include further evaluating which operations and/or market segments may receive available entity resources by identifying which operations and/or market segments represent substantial impacts with respect to market segments and/or market sectors, respectively. It is contemplated that method 10 may selectively omit step 24. It is also contemplated that the economic data may be determined from any suitable source and/or via any suitable method, such as, for example, experience or historical information, market analysis, and/or anticipated or predicted amounts of revenue generated from the performance of an operation, market segment, and/or market sector.

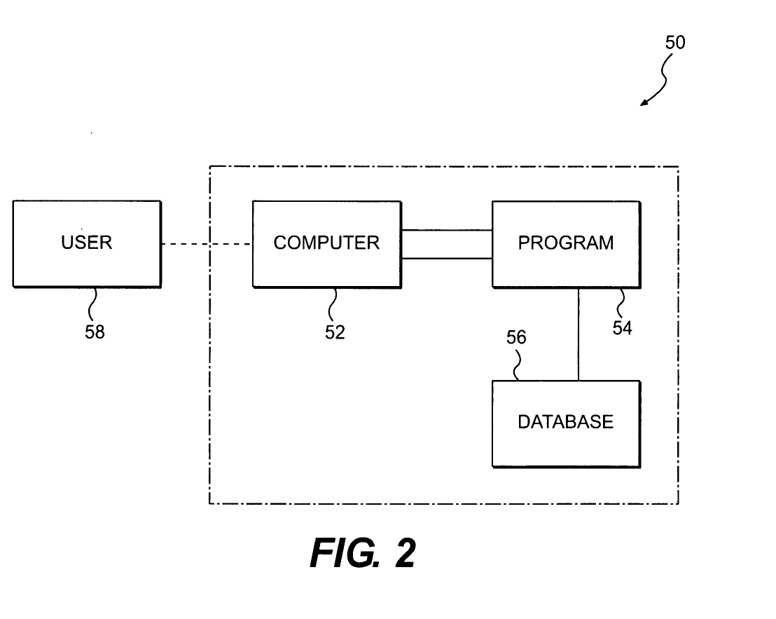

FIG. 2 illustrates an exemplary work environment 50 for performing method 10. Work environment 50 may include a computer 52, a program 54, and database 56. Work environment 50 may be configured to accept inputs from user 58 via computer 52 to perform a competitive assessment. Work environment 50 may be further configured to communicate and/or display data or graphics to user 58 via computer 52. It is contemplated that work environment 50 may include additional components such as, for example, a communications interface (not shown), a memory (not shown), and/or other components known in the art.

Computer 52 may include a general purpose computer configured to operate executable computer code. Computer 52 may include one or more input devices, e.g., a keyboard (not shown) or a mouse (not shown), to introduce inputs from user 58 into work environment 50 and may include one or more output devices, e.g., a monitor, to deliver outputs from work environment 50 to user 58. Specifically, user 58 may deliver one or more inputs, e.g., data, into work environment 50 via computer 52 to supply data associated with any of the steps of method 10 to and/or execute program 54. Computer 52 may also include one or more data manipulation devices, e.g., data storage or software programs (not shown), to transfer and/or alter user inputs. Computer 52 may also include one or more communication devices, e.g., a modem (not shown) or a network link (not shown), to communicate inputs and/or outputs with program 54. It is contemplated that computer 52 may further include additional and/or different components, such as, for example, a memory (not shown), a communications hub (not shown), a data storage (not shown), a printer (not shown), an audio-video device (not shown), removable data storage devices (not shown), and/or other components known in the art. It is also contemplated that computer 52 may communicate with program 54 via, for example, a local area network (“LAN”), a hardwired connection, and/or the Internet. It is further contemplated that work environment 50 may include any number of computers and that each computer associated with work environment 50 may be accessible by any number of users for inputting data into work environment 50, communicating data with program 54, and/or receiving outputs from work environment 50.

Program 54 may include a computer executable code routine configured to perform one or more sub-routines and/or algorithms to perform a competitive assessment within work environment 50. Specifically, program 54, in conjunction with user 58, may be configured to perform one or more steps of method 10. Program 54 may receive inputs, e.g., data, from computer 52 and perform one or more algorithms to manipulate the received data. Program 54 may also deliver one or more outputs, e.g., algorithmic results, and/or communicate, e.g., via an electronic communication, the outputs to a user via computer 52. Program 54 may also access database 56 to locate and manipulate data stored therein to arrange and/or display stored data to user 58 via computer 52, e.g., via an interactive object oriented computer screen display and/or a graphical user interface. It is contemplated that program 54 may be stored within the memory (not shown) of computer 52 and/or stored on a remote server (not shown) accessible by computer 52. It is also contemplated that program 54 may include additional sub-routines and/or algorithms to perform various other operations with respect to mathematically representing data, generating or importing additional data into program 54, and/or performing other computer executable operations. It is further contemplated that program 54 may include any type of computer executable code, e.g., C++, and/or may be configured to operate on any type of computer software.

Database 56 may be configured to store and arrange data and to interact with program 54. Specifically, database 56 may be configured to store a plurality of data, e.g., data associated with any of the steps of method 10. Database 56 may store and arrange any quantity of data arranged in any suitable or desired format. Program 54 may be configured to access database 56 to identify particular data therein and display such data to a user. It is contemplated that database 56 may include any suitable type of database such as, for example, a spreadsheet, a two dimensional table, or a three dimensional table, and may arrange and/or store data in any manner known in the art, such as, for example, within a hierarchy or taxonomy, in groupings according to associated documents, and/or searchable according to associated identity tags. It is also contemplated that database 56 may include a single database and/or any quantity of databases.

### INDUSTRIAL APPLICABILITY

The disclosed system may be applicable for performing a competitive assessment and may be applicable to any market sector. Method 10 may be utilized to identify one or more operations of an entity that represent an advantage or disadvantage with respect to one or more competitors within a identified market sector. The operation of method 10 is described below with respect to a product distribution market sector for exemplary purposes only and it is understood that method 10 is applicable to any type of market sector.

An entity, e.g., a company, may desire to assess its competitive performance within a product distribution market sector, e.g., providing logistical operations to clients (step 12). Accordingly, the company may identify a plurality of competitors that may be known by the company to be its closest competitors. For example, the company may have a substantial market presence within the product distribution market sector and, as such, may identify the top three competitors therein (step 14). The company may identify one or more market segments, e.g., receiving, warehousing, or transporting, and at least one operation, e.g., cross docking, repacking, picking, sequencing, kitting, sub-assembling, or shipping preparation, within the market sector (step 16). The company may also conduct research and/or surveys regarding its performance and the performance of the three identified competitors (step 16). For example, the company may establish data regarding the ability, e.g., the capability, deliverability, and/or the quality, of the entity to perform an operation via surveys of current employees, former employees, and/or customers. It is contemplated that step 16 and others may be outsourced to a consultant-style organization and will nonetheless be considered as being performed by the company.

The company may also determine a rating (step 18) for the identified operations, market segments, and market sectors by evaluating the data compiled within step 16. For example, the company may obtain a rating of 3 for itself, and 2, 1, and 1 for the three identified competitors with respect to the cross docking operation. For example, the company may average multiple survey results to obtain numerical ratings for capability, deliverability, and/or quality with respect to cross docking and average the numerical ratings to obtain a combined rating for cross docking for the company and each competitor. The different ratings may be a function of any criteria or phenomena known in the art, such as, for example, the company and competitors utilizing different methods of cross docking, having different levels of experience in cross docking, having different labor capacities, and/or implementing different cross docking philosophies.

The company may also evaluate the ratings determined within step 18 to identify one or more operations of advantage (step 20). For example, the company may identify an advantage within the market sector with respect to cross docking because its rating is greater than the respective ratings of the three competitors. Alternatively, the company may identify an advantage with respect to the two competitors having ratings of “one” because its rating of “three” is greater than the competitors' rating of “one” plus a predetermined factor of, for example, “one” previously determined to indicate an operation of advantage.

The company may further evaluate the impact of the identified advantage by comparing the weighting of the cross docking operation with respect to, for example, warehousing (step 22). Additionally, the company may have also identified advantages and/or disadvantages within one or more other operations and may wish to determine what operations should receive a portion of a limited amount of company resources, e.g., capital for improvements or new equipment, training, additional labor, evaluation and implementation of new operating methods, and/or any other type of available company resource. The company may determine that cross docking has a relatively high weighting and should receive a corresponding portion of company resources to attempt to maintain the advantage with respect to two competitors and potentially improve the advantage with respect to one competitor. Furthermore, the company may selectively evaluate the revenue stream associated with cross docking to determine if it has an undesirable revenue stream, e.g., cyclic or decreasing (step 24). For example, the company may identify the revenue streams for cross docking as substantially non-cyclic, comparatively, identify a revenue stream for storing as substantially cyclical, and, thus may further identify cross docking as a significant impact operation.

Because method 10 may compare an entity's operation with one or more entities' operations, it may identify one or more advantages or disadvantages within a market segment and/or market sector. Additionally, method 10 may compile data with respect to an entity's capability, deliverability, and quality that may provide a more accurate assessment of an entity's ability to perform a particular operation.

It will be apparent to those skilled in the art that various modifications and variations can be made to the disclosed system for performing a competitive assessment. Other embodiments will be apparent to those skilled in the art from consideration of the specification and practice of the disclosed method and apparatus. It is intended that the specification and examples be considered as exemplary only, with a true scope being indicated by the following claims and their equivalents

What is claimed is:

1. A method for evaluating at least one operation associated with a market sector comprising:
determining a first entity and at least one second entity performing the at least one operation within the market sector to produce a desired output;
compiling data indicative of the first entity and the at least one second entity respectively performing the at least one operation;
determining a first value and at least one second value as a function of the compiled data, the first and at least one second value being indicative of a respective ability of the first and the at least one second entity to perform the at least one operation; and
evaluating the at least one operation as an advantage of the first entity over the second entity with respect to the market sector if the first value is greater than the at least one second value.

2. The method of claim 1, wherein determining the first value includes evaluating the at least one operation with respect to at least one of a capability of the first entity to perform the operation, a deliverability of an entity to provide the desired output of the operation, or quality of the desired output of the operation.

3. The method of claim 1, wherein determining the second value includes evaluating the at least one operation with respect to at least one of a capability of the at least one second entity to perform the operation, a deliverability of an entity to provide the desired output of the operation, or quality of the desired output of the operation.

4. The method of claim 1, wherein compiling data indicative of the at least one second entity includes conducting at least one survey of at least one individual associated with the at least one second entity as either a present employee or a former employee.

5. The method of claim 1, wherein the first entity and the at least one second entity are competitors within the market sector.

6. The method of claim 1, wherein the first entity and the at least one second entity perform substantially different operations to achieve a substantially similar desired output.

7. The method of claim 1, wherein the at least one operation includes at least one of a cross docking, repacking, picking, sequencing, kitting, sub-assembling, or shipping preparation.

8. A work environment for performing a competitive assessment between at least two entities competing within a market sector comprising:
a computer configured to receive a plurality of inputs from a user, at least a first portion of the plurality of inputs being indicative of an ability of each of the at least two entities for performing at least one operation associated with the market sector;
a database configured to store data indicative of the at least first portion of the plurality of inputs; and
a program configured to perform a first algorithm configured to arrange the data within the database and operatively associate the data with each of the respective at least two entities.

9. The work environment of claim 8, wherein the computer is further configured to display the arranged data to identify at least one advantage of one of the at least two entities over the other of the at least two entities as a function of at least one additional input from the user.

10. The work environment of claim 9, wherein the at least one operation is a plurality of operations;
the program is further configured to determine a plurality of values each indicative of the plurality of operations to evaluate respective ones of the plurality of values with one another; and
identifying the at least one competitive advantage includes determining one of the plurality of values that is higher than other ones of the plurality of values.

11. The work environment of claim 8, wherein the data stored within the database is further indicative of at least one of a capability, deliverability, or quality of a respective entity to perform the at least one operation.

12. The work environment of claim 8, wherein the data stored within the database is further indicative of a numerical rating of the respective ability of an entity to perform the at least one operation.

13. The work environment of claim 8, wherein the at least one operation is a plurality of operations configured to be interrelated to produce an output associated with the market sector.

14. The work environment of claim 8, wherein:
one of the at least two entities performs a first type of operation producing a first output;
the other one of the at least two entities performs a second type of operation producing a second output;
the first and second types of operations are substantially dissimilar; and
the first and second types of outputs are substantially similar.

15. A method for performing a competitive assessment comprising:
identifying at least one market sector in which an entity operates;
determining at least one competitor with respect to the entity within the at least one market sector;
determining at least one operation separately performed by the entity and the at least one competitor to achieve respective outputs associated with the market sector;
establishing data associated with the at least one operation with respect to the entity and the at least one competitor;
determining ratings indicative of the entity and the at least one competitor performing the operation; and
evaluating the determined ratings with respect to one another and identifying an advantage with respect to the entity if the rating for the entity is greater than the rating for the competitor.

16. The method of claim 15, further including identifying an advantage of the entity and identifying an impact of the advantage as a function of the significance of the at least one operation with respect to the identified market sector.

17. The method of claim 15, wherein the at least one operation is a plurality of operations and determining ratings includes:
establishing a weighting for each of the plurality of operations; and
determining a combined rating for each of the entity and the competitor as a function of the compiled data and the established weighting.

18. The method of claim 17, wherein determining a combined rating includes averaging a rating for each of the plurality of operations as a function of the respective weighting for each of the plurality of operations.

19. The method of claim 15, wherein the at least one operation is one of a cross docking, repacking, picking, sequencing, kitting, sub-assembling, or shipping preparation.

20. The method of claim 15, further including identifying an advantage of the entity and evaluating the identified advantage with respect to a predetermined amount of revenues associated with either the at least one operation or the market sector.
